(19) United States
(12) Patent Application Publication
(10) Pub. No.: US 2014/0325092 A1
(43) Pub. Date: Oct. 30, 2014

(54) CONFIGURATION OF A PHYSICAL CHARACTERISTIC OF PERIPHERAL DEVICE

(71) Applicant: HEWLETT- PACKARD DEVELOPMENT COMPANY, L.P., Houston, TX (US)

(72) Inventors: Robert Francis Yockey, Ft. Collins, CO (US); Robert Adam Baum, Ft. Collins, CO (US); David H. Hanes, Ft. Collins, CO (US); Rudy Widiaman, Ft. Collins, CO (US)

(73) Assignee: HEWLETT-PACKARD DEVELOPMENT COMPANY, L.P., Houston, TX (US)

(21) Appl. No.: 13/870,848

(22) Filed: Apr. 25, 2013

(51) Int. Cl. G06F 13/10

(52) U.S. Cl. CPC G06F 13/10
USPC 710/10

(57) ABSTRACT

An example apparatus in accordance with one implementation of the present disclosure includes an actuator to configure a physical characteristic of a peripheral device in communication with a primary device and a controller to obtain user preferences associated with an identity of a user of the primary device and to control the actuator to configure the physical characteristic in accordance with the user preferences.

### BACKGROUND

Peripheral devices may be used in various capacities along with devices such as computing devices, televisions or other devices. In the case of computers, peripheral devices may include a keyboard and a mouse for providing input to the computing device. In the case of a television, a remote control, a wireless keyboard or a wireless mouse may be used as a peripheral device.

### BRIEF DESCRIPTION OF THE DRAWINGS

For a more complete understanding of various examples, reference is now made to the following descriptions taken in connection with the accompanying drawings in which:

FIG. 1 illustrates an example system;

FIG. 2 illustrates another example system;

FIG. 3 is a flowchart illustrating an example process;

FIG. 4 illustrates an example mouse for use as a peripheral device; and

FIGS. 5A and 5B illustrate an example keyboard for use as a peripheral device.

### DETAILED DESCRIPTION

In various examples, one or more physical characteristics of a peripheral device may be configured according to the identity of a user of a primary device, such as a computing device. In some examples, the physical characteristics may be configured in accordance with ergonomic considerations for the identified user. The identity of the user may be determined based on, for example, a login identifier or biometric information (e.g., finger print) used by the user to access a computing device. Based on the identity of the user, certain preferences associated with the user may be accessed. The user preferences may be used to determine a setting for a physical characteristic, such as size, for the peripheral device. An actuator, such as a stepper motor, may be provided in the peripheral device to configure the physical characteristic. For example, a stepper motor may be used to move one or more plates on a mouse to increase or decrease the size or form factor of the mouse to accommodate the identified user. Thus, a single peripheral device may be effectively and conveniently used by multiple users of a primary device.

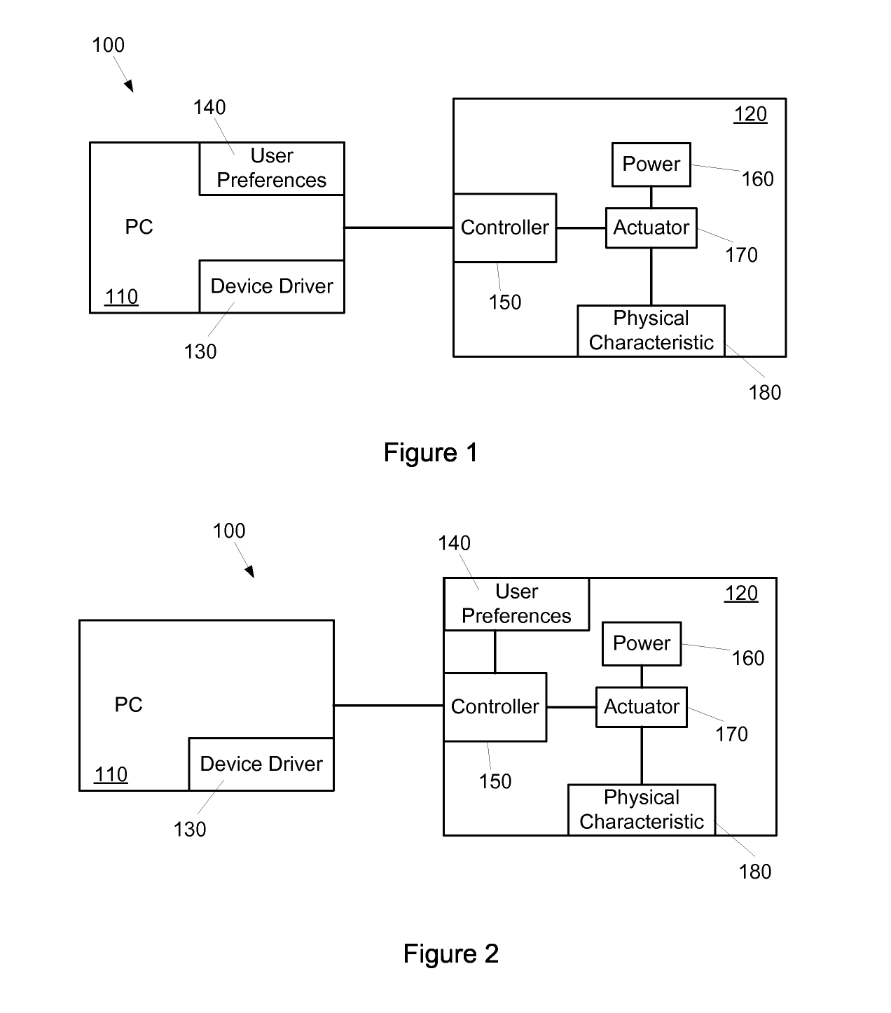

Referring now to FIG. 1, an example system is illustrated. The example system 100 may include a primary device 110, such as a computing device or a television, for example. The primary device 110 may be in communication with a peripheral device 120, such as a mouse or a keyboard for a computing device or a remote control for a television, for example. The primary device 110 and the peripheral device 120 may communicate with each other through, for example a wired connection (e.g., a universal serial bus (USB)) or a wireless connection (e.g., Bluetooth or WiFi).

In various examples, the primary device 110 may be provided with a device driver 130 associated with the peripheral device 120. The device driver 130 may be an application or other software (e.g., machine readable instructions) which facilitates communication between the primary device 110 and the peripheral device 120. In various examples, the device driver 130 may allow the primary device 110 to send commands to and receive commands from the peripheral device 120.

In various examples, the primary device 110 may be usable by multiple users. For examples, the primary device 110 may be a computing device that may be used by different members of a family or different employees in an office. In this regard, the primary device 110 may store user preferences 140 associated with one or more of the users. In various examples, the user preferences 140 may include a table of settings associated with each user. For example, the user preferences 140 may include the desired settings for the peripheral device 120 for each user in a family.

In various examples, the peripheral device 120 may include a controller 150 to control various functions or features of the peripheral device 120. For example, if the peripheral device 120 is a mouse, the controller 150 may detect movement of the mouse and communicate signals to the primary device 110 to accordingly move a cursor. As described below, in various examples, the controller 150 may control other features of the peripheral device 120.

In the illustrated example of FIG. 1, the peripheral device 120 includes a power source 160. The power source 160 may be batteries that may be inserted into the peripheral device 120. In other examples, the power source 160 may be replaced with power received by the peripheral device 120 from the primary device 110 through a wired connection, for example.

In various examples, the peripheral device 120 may include one or more actuators 170 to configure one or more physical characteristics, such as the physical characteristic 180. In one example, the actuator 170 is a stepper motor that may be sized for a desired function. Of course, in various examples, the actuator 170 may include any of a variety of types of actuators. As described below, the physical characteristic 180 may be a variety of physical characteristics associated with the particular peripheral device.

Thus, in one example, a user may access the primary device 110. In various examples, the primary device 110 may be accessed by the user using a login identifier. In other examples, biometric sensors (not shown) may be provided to detect the identity of the user. For example, a fingerprint scanner (not shown) may be provided on the primary device 110 or the peripheral device 120 to determine the identity of the user. Based on the identity of the user, the primary device 110 or the peripheral device 120 (e.g., via the controller 150) may access the user preferences 140 and determine the preferences or settings for the identified user. The actuator 170 may then be controlled to configure one or more physical characteristics of the peripheral device based on the user preferences associated with the identified user.

In one example, a processor of the primary device 110 may determine the identity of the user, access the user preferences 140 stored on the primary device 110 and determine the preferences or settings of the peripheral device 120 associated with the user. The primary device 110 may then send commands to the controller 150 of the peripheral device 120 to control the actuator 170 to configure the physical characteristic 180.

In another example, the peripheral device 120 may determine the identity of the user using, for example, biometric sensors positioned on the peripheral device 120. The controller 150 of the peripheral device 120 may then send signals to the primary device 110 to request user preferences 140 associated with the identified user. The controller 150 may then control the actuator 170 to configure the physical characteristic 180.

In another example, the controller 150 may determine the identity of the user based on information from the primary device 110 (e.g., user login identifier) or based on information obtained directly from the user (e.g., biometric data sensed using biometric sensors on the peripheral device 120). As illustrated in the example of FIG. 2, the user preferences 140 for the peripheral device 120 for various users may be stored on the peripheral device 120. The controller 150 may determine the user preferences associated with the identified user and may control the actuator 170 to configure the physical characteristic 180.

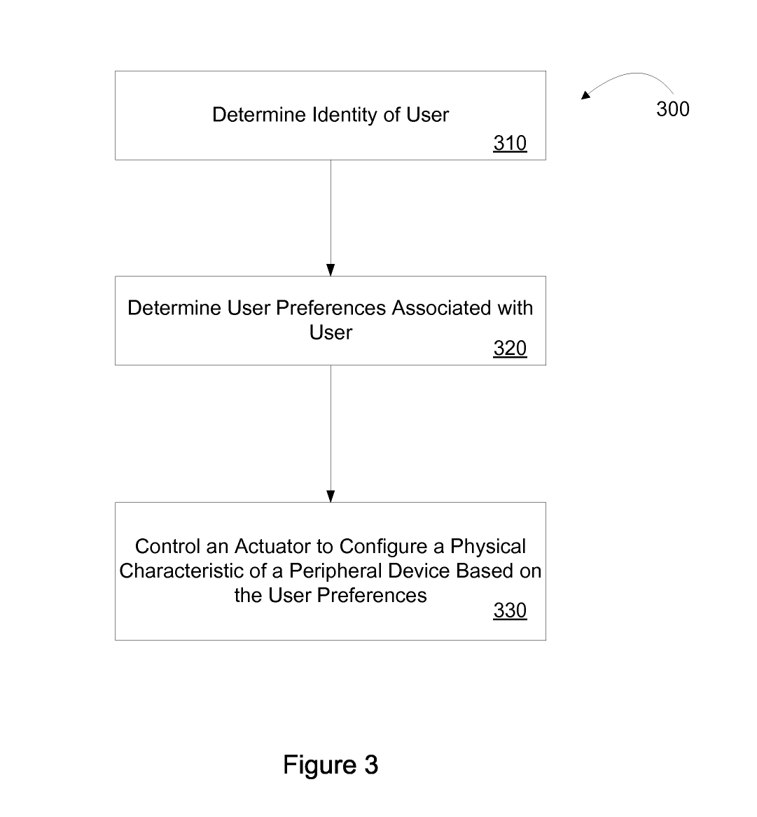

Referring now to FIG. 3, a flowchart illustrates an example process 300 for configuring one or more physical characteristics of a peripheral device. The process begins with the determination of the identity of a user (block 310). As noted above, the identity of the user may be determined by the primary device or the peripheral device using, for example, a login identifier or biometric data from biometric sensors positioned on either the primary device or the peripheral device.

Based on the identity of the user, user preferences or settings associated with the identified user may be determined (block 320). In various examples, the user preferences may be stored on the primary device or the peripheral device. The actuator may then be controlled to configure one or more physical characteristics of the peripheral device based on the user preferences associated with the identified user (block 330). In various examples, the actuator may be controlled by the primary device through commands sent from the primary device to the peripheral device (e.g., to a controller on the peripheral device). In other examples, the controller of the peripheral device may obtain the user preferences and may control the actuator to configure the physical characteristic based on the user preferences associated with the identified user.

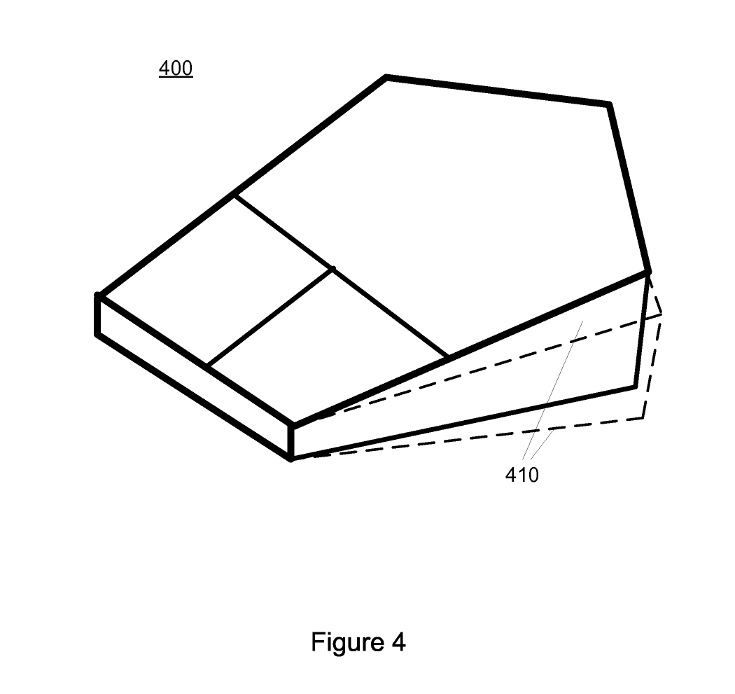

Referring now to FIG. 4, an example mouse for use as a peripheral device is illustrated. The example mouse 400 of FIG. 4 may be provided with an actuator, such as a stepper motor, within the body of the mouse 400. Other components (e.g., controller, power supply, etc.) may also be provided within the body of the mouse 400. The example mouse 400 may communicate with a primary device, such as a computing device, through a wired (e.g., USB connection) or wireless (e.g., Bluetooth) connection, as described above.

In the illustrated example of FIG. 4, the actuator may configure one or more physical characteristics of the mouse 400. In this regard, in the example of FIG. 4, the actuator may configure a size of the mouse 400 based on the user preference, such as to accommodate the size of the hand of the user. In the illustrated example of FIG. 4, the mouse 400 may have one or more walls, such as the wall 410, that are movable to increase or decrease the form factor of the mouse. As illustrated in the example of FIG. 4, the wall 410 may move from a first position (as illustrated by the solid lines in FIG. 4) to a second position (as illustrated by the dashed lines in FIG. 4). Other walls or surfaces may be similarly moved to configure the size of the mouse in accordance with the user preferences associated with an identified user.

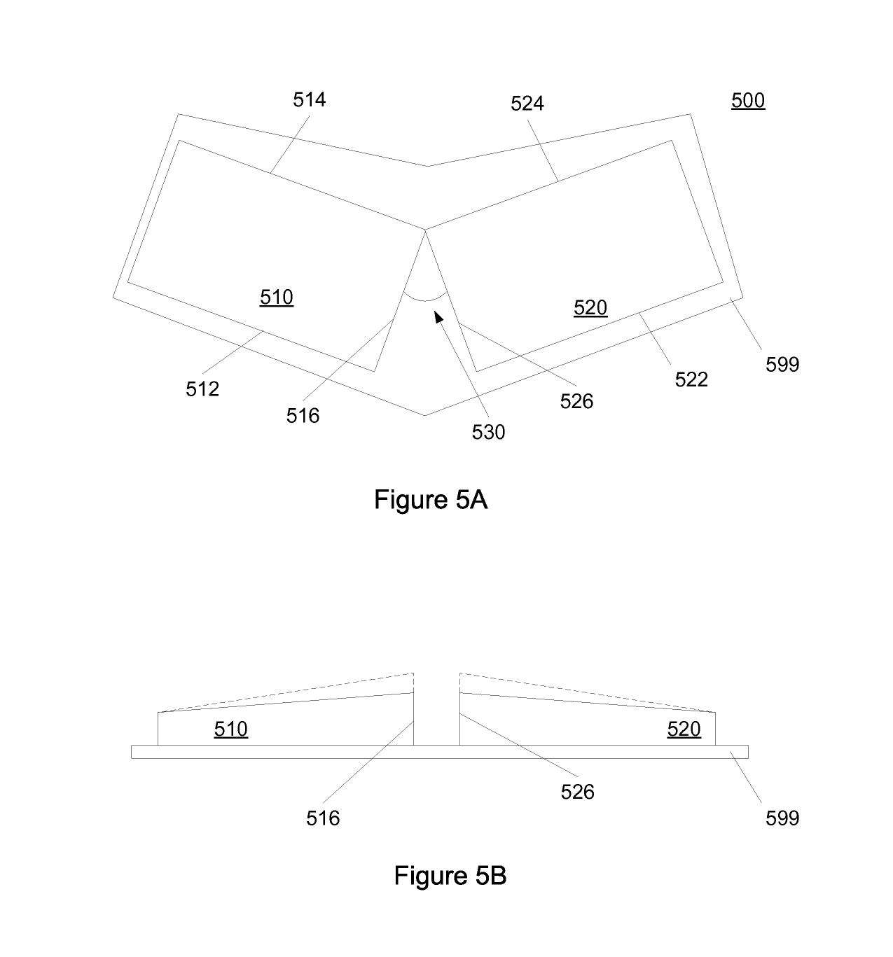

Referring now to FIGS. 5A and 5B, an example keyboard 500 for use as a peripheral device is illustrated. The example keyboard 500 may be an ergonomic keyboard with a split set of keys. In this regard, the example keyboard 500 includes a left keyboard segment 510 and a right keyboard segment 520. Each of the keyboard segments 510, 520 has a front edge 512, 522, a back edge 514, 524 and an inside edge 516, 526.

The example keyboard 500 of FIGS. 5A and 5B may be provided with at least one actuator, such as a stepper motor, within the body of the keyboard 500. Other components (e.g., controller, power supply, etc.) may also be provided within the body of the keyboard 500. In various examples, the keyboard segments 510, 520 may be positioned on a keyboard base 599. In one example, certain components of the example keyboard 500, such as the power supply, the controller and the actuator (e.g., stepper motor) may be housed in a keyboard base 599. The example keyboard 500 may communicate with a primary device, such as a computing device, through a wired (e.g., USB connection) or wireless (e.g., Bluetooth) connection, as described above.

In the illustrated example of FIGS. 5A and 5B, the actuator may configure one or more physical characteristics of the keyboard 500. In this regard, in the example of FIGS. 5A and 5B, the actuator may configure various physical characteristics of the keyboard 500 based on the user preference.

For example, as noted above, the example keyboard 500 includes keyboard segments 510, 520. As illustrated in FIG. 5A, the keyboard segments 510, 520 are separated by a split angle 530. In one example, the physical characteristic configured based on the user preference is the split angle 530. In this regard, a stepper motor provided in the keyboard base 599 may be used to move the keyboard segments 510, 520 on the keyboard base 599 to configure the split angle 530 in accordance with the user preferences.

In another example, a tenting angle of the example keyboard 500 may be configured based on the user preferences. In this regard, as illustrated in the example of FIG. 5B, the stepper motor may be used to raise or lower the inside edges 516, 526 of the keyboard segments 510, 520. In the example of FIG. 5B, the tenting angle may be configured based on the user preferences by moving the keyboard segments from a first position (as indicated by the solid lines) to a second position (as indicated by the dashed lines). The tenting angle may be configured by, as noted above, raising the inside edges 516, 526.

In another example, tilting of the example keyboard 500 may be configured based on the user preferences. In this regard, the stepper motor may be used to raise or lower the back edges 514, 524 of the keyboard segments 510, 520. Thus, the user preferences may be used to configure one or more physical characteristics of the example keyboard 500.

While FIGS. 4, 5A and 5B illustrate certain peripheral devices and certain physical characteristics, those skilled in the art will understand that various other peripheral devices and various other physical characteristics may be configured and are contemplated within the scope of the present disclosure. For example, in other examples, the peripheral devices may include remote controls, laser pointers, or the like. In one example, the peripheral device may be a mouse pad, and the physical characteristic may be a color, pattern or image of the mouse pad. In this regard, an electronic ink system may be actuated to present the desired color, pattern or image in accordance with user preferences.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

1. An apparatus, comprising:
an actuator to configure a physical characteristic of a peripheral device in communication with a primary device; and
a controller to obtain an identity of a user of the primary device, to obtain user preferences associated with the determined identity of the user of the primary device and to control the actuator to configure the physical characteristic in accordance with the user preferences associated with the determined identity of the user of the primary device.

2. The apparatus of claim 1, wherein the peripheral device in communication with the primary device is a mouse.

3. The apparatus of claim 2, wherein the physical characteristic is a size of the mouse.

4. The apparatus of claim 3, wherein the actuator is a motor to move at least one plate to configure the size of the mouse.

5. The apparatus of claim 1, wherein the peripheral device in communication with the primary device is a keyboard.

6. The apparatus of claim 5, wherein the physical characteristic is at least one of a split angle or a tenting angle.

7. The apparatus of claim 1, wherein the actuator includes at least one stepper motor.

8. A method, comprising:
determining an identity of a user of a primary device;
determining user preferences associated with user; and
controlling an actuator to configure a physical characteristic of a peripheral device in communication with the primary device in accordance with the user preferences associated with the determined identity of the user.

9. The method of claim 8, wherein the peripheral device in communication with the primary device is a mouse.

10. The method of claim 9, wherein the physical characteristic is a size of the mouse.

11. The method of claim 10, wherein controlling the actuator includes causing a motor to move at least one plate to configure the size of the mouse.

12. The method of claim 8, wherein the peripheral device in communication with the primary device is a keyboard.

13. The method of claim 12, wherein the physical characteristic is at least one of a split angle or a tenting angle.

14. The method of claim 8, wherein the actuator includes at least one stepper motor.

15. A system, comprising:
a primary device; and
a peripheral device in communication with the primary device, the peripheral device comprising:
an actuator to configure a physical characteristic of the peripheral device; and
a controller to determine an identity of the user and to obtain user preferences associated with the identity of the user of the primary device and to control the actuator to configure the physical characteristic in accordance with the user preferences associated with the identity of the user.

16. The system of claim 15, wherein the peripheral device is a mouse.

17. The system of claim 16, wherein the physical characteristic is a size of the mouse.

18. The system of claim 17, wherein actuator is a motor to move at least one plate to configure the size of the mouse.

19. The system of claim 15, wherein the peripheral device is a keyboard.

20. The system of claim 19, wherein the physical characteristic is at least one of a split angle or a tenting angle.
